(19) United States
(12) Patent Application Publication
(10) Pub. No.: US 2006/0243073 A1
(43) Pub. Date: Nov. 2, 2006

(54) Door drive with belt-like drive means and elevator installation with such a door drive

(76) Inventors: Gert Silberhorn, Rigi (CH); Daniel Keiser, Cham (CH); Urs Baumgartner, Merenschwand (CH)

Correspondence Address: BUTZEL LONG;DOCKETING DEPARTMENT, 100 BLOOMFIELD HILLS PARKWAY, SUITE 200, BLOOMFIELD HILLS, MI, 48304, US

(21) Appl. No.: 11/371,711

(22) Filed: Mar. 9, 2006

(30) Foreign Application Priority Data
Mar. 9, 2005 (EP) 05101836.4

(51) Int. Cl. F16H 27/02; F16H 29/02; F16H 29/20

(52) U.S. Cl. 74/89; 74/89.2; 74/89.22

(57) ABSTRACT

A door drive has a drive unit and a belt-like drive for moving at least one door leaf. At least one electrically conductive element extends in a longitudinal direction of the belt-like drive for transmission of electrical signals or energy to/from the at least one door leaf. A first contact device extends into a longitudinal groove formed in the belt-like drive enabling access to the at least one electrically conductive element. When the belt-like drive is moving past the first contact device, the first contact device produces a permanent contact with the at least one electrically conductive element.

### BACKGROUND OF THE INVENTION

The invention relates to a door drive with a belt-like drive means for moving at least one door leaf of a sliding door and to an elevator installation with such a door drive.

There are door installations in which door leaves are moved by a drive motor via a belt drive. The door leaves are usually equipped with sensors or other electrical means. An electrical connection to the moved door leaf has to be provided for this. Door installations are typically equipped, for this purpose, with so-termed hanging cables or looped lines in order to supply the door leaf with current or in order to be able to transmit, for example, signals from sensors located at the door leaf.

European patent document EP 0 825 146 discloses an elevator door system in which two car door leaves of an elevator car as well as the respective corresponding shaft door leaf of a shaft door are moved in opening and closing directions with the help of a belt driven by a door motor. An electromagnetically actuated spreading device with two entraining rollers is present on one of the car door leaves and co-operates with entrainer skids at the corresponding shaft door leaves during opening and closing so as to couple the car door leaf with the shaft door leaf. The spreading device in that case increases the mutual horizontal spacing of the entraining rollers, whereby on the one hand a play-free coupling and on the other hand unlocking of the shaft door are produced. The electromagnetic actuation of the spreading device requires current feed from the elevator car to the car door leaf, which is displaceable relative to the elevator car.

Operational disturbances can occur in such door installations if, for example, the hanging cables are mechanically damaged or loop lines rendered functionally incapable as a consequence of contamination or mechanical loading. Hanging cables, as also loop lines, can in addition cause disruptive noises. The provision and mounting of hanging cables or loop lines is costly. A significant disadvantage of the use of hanging cables or loop lines is that these demand a relatively large amount of installation space in the region of the door leaves.

### SUMMARY OF THE INVENTION

It is therefore an object of the present invention to offer a solution for transmission of energy and/or signals to the movable door leaves of a door drive, especially an elevator door drive, which demands as little as possible space particularly in the region of the door leaves, ensures a high level of serviceability and does not impair user convenience.

It is a further object of the present invention to propose a system for transmission of energy and/or signals which is usable in different door variants at different installation locations and which can be installed in simple and problem-free manner.

The advantages achieved by the present invention are that an electrical feed to electrical components, which are mounted on a moved sliding door leaf, is realized by way of a belt-like drive means, which is present in any case, for the sliding door leaf. Such an electrical feed is space-saving and low in noise output, not susceptible to mechanical damage or contamination problems and usable in the most diverse installation conditions.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1A is a schematic cross-section through a cogged belt and first contact means with a presser roller, according to the present invention;

FIG. 1B is a schematic sectional view of the cogged belt, which is shown in FIG. 1A, with the first contact means with a presser roller;

FIG. 2A is a schematic longitudinal section through a cogged belt and with a second contact means, which are connected therewith, with contact elements, according to the present invention;

FIG. 2B is a schematic cross-section taken along the section line A-A through the cogged belt, which is shown in FIG. 2A, with the second contact means;

FIG. 3A is an elevation view of a door drive of an elevator installation according to the present invention, wherein both door leaves are closed; and

FIG. 3B is an elevation view of the door drive according to FIG. 3A, wherein both door leaves are open.

### DESCRIPTION OF THE PREFERRED EMBODIMENT

The present invention relates to door drives which are equipped with a belt-like drive means and a drive unit for moving one or more door leaves.

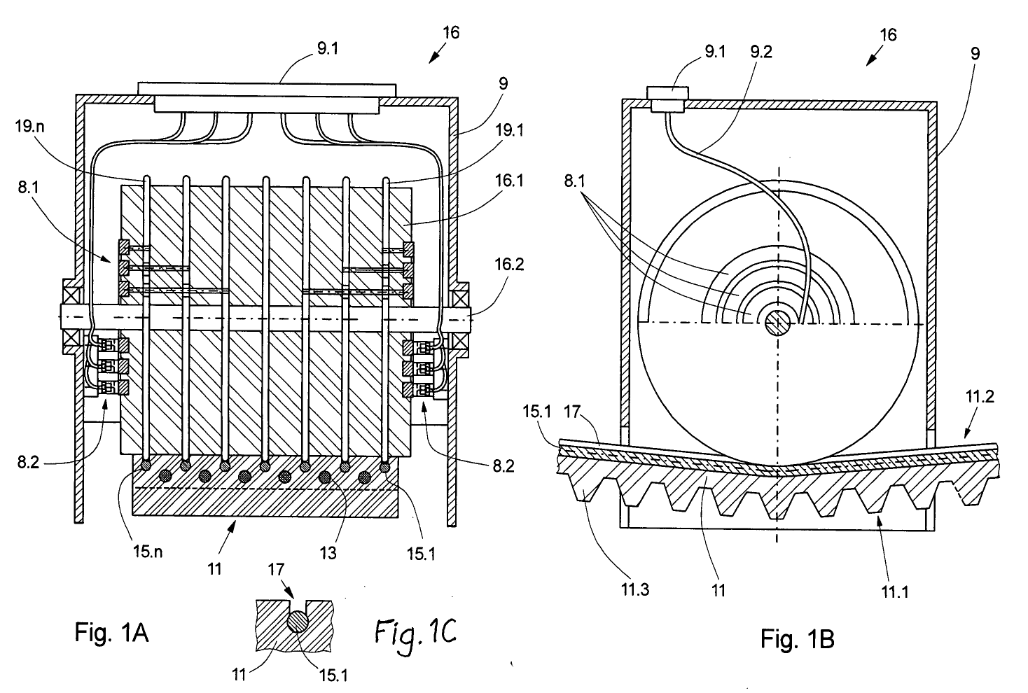

According to the present invention use is made of a special drive means 11 which is shown by way of example in FIGS. 1A and 1B together with a first contact means 16. According to the present invention an electrically conductive element or several electrically conductive elements 15.1 to 15.n for transmission of signals and/or energy are provided in the drive means 11 in order to enable signal and/or energy transmission between electrical means moving with a door leaf and an electrical circuit or control not moving with the door leaf. In FIG. 1A there can be seen n=7 electrically conductive elements in the sectional area of the drive means 11. Some of tensile means 13, which increase the permissible tensile loading of the belt-like drive means 11 and lie deeper in the drive means, are also shown.

According to the present invention the belt-like drive means can be equipped with tensile means in the form of metallic (for example, steel or copper strands) or non-metallic strands (for example, aramide strands), synthetic fibers P.B.O. (called Zylon, a registered trademark of Toyo Boseki Kabusiki Kaisha TA Toyobo Co., Ltd. of Osaka Japan) or the like in order to impart to the drive means an additional tensile strength and/or longitudinal stiffness.

The electrically conductive elements 15.1 to 15.n extend parallel to the longitudinal direction of the drive means 11. In order to be able to produce an electrical contact, the first contact means 16, relative to which the drive means 11 moves, are provided in the region of the drive means 11. At least one longitudinal groove 17 is provided at the drive means 11 (see FIG. 1C which is an enlargement of a portion of FIG. 1A) and extends parallel to the longitudinal direction of the drive means 11. The longitudinal groove 17 enables access of the first contact means 16 to the at least one electrically conductive element 15.1 to 15.n, wherein the longitudinal groove is executed with a smaller width than a diameter of the representative element 15.1 so as to ensure that the electrically conductive elements 15.1 to 15.n cannot be unintentionally contacted by persons.

In the illustrated form of embodiment the first contact means 16 are constructed in such a manner and so arranged with respect to the drive means 11 that when the drive means 11 is moving this runs past the first contact means 16, the first contact means 16 producing a permanent contact with the at least one electrically conductive element 15.1 to 15.n.

Further embodiments of the first contact means and further details with respect to the drive means according to the present invention are described in the following.

The drive means 11 typically has a front side 11.1 and a rear side 11.2. The longitudinal grooves 17 are disposed on the rear side 11.2 of the drive means 11. The rear side 11.2 of the drive means 11 moves past the first contact means 16 and the first contact means 16 produce the permanent contact with the electrically conductive elements 15.1 to 15.n from the rear side 11.2 of the drive means 11.

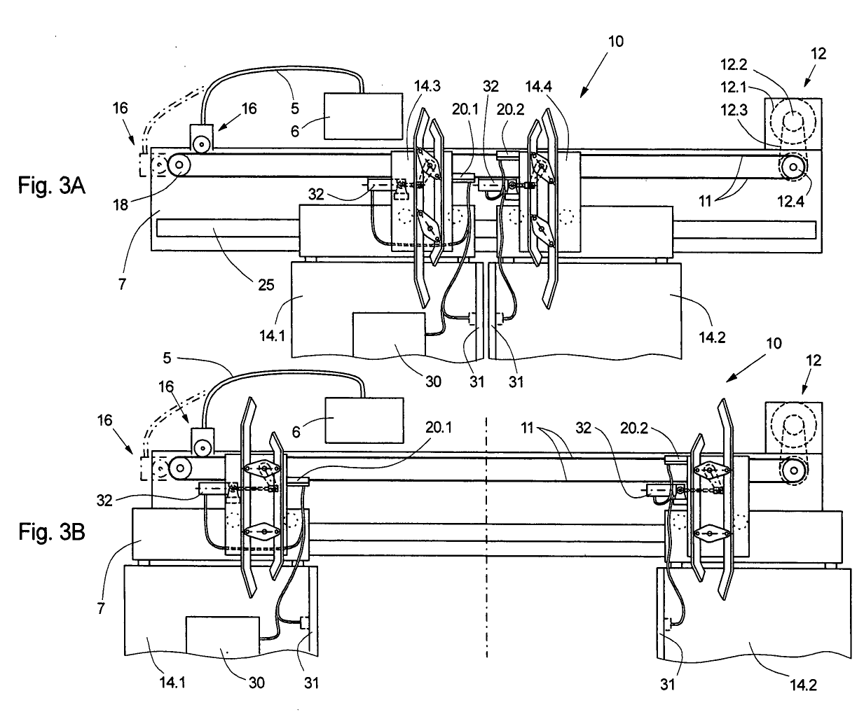

The drive means 11 is preferably a cogged belt, as can be seen in FIGS. 1A and 1B, on the front side 11.1 of which teeth 11.3 are provided. Such a cogged belt 11 can run around a drive pulley (see pulley 12.4 in FIG. 3A) with a shape-locking couple therewith. Such a drive pulley can be part of a drive unit.

In a particularly preferred form of embodiment, which is shown in FIGS. 1A and 1B, the first contact means 16 comprises rotatably mounted contact elements 19.1 to 19.n. These contact elements 19.1 to 19.n engage at least partly in the longitudinal grooves 17 in order to enable contact with the respective electrically conductive elements 15.1 to 15.n.

This particularly preferred form of embodiment of the contact means 16 according to the present invention comprises a presser roller 16.1. A schematic cross-section is shown in FIG. 1A. FIG. 1B shows a partly sectioned side view. As mentioned, the drive means 11 is a cogged belt 11 which has the teeth 11.3 on the front side 11.1. Provided on the rear side 11.2 of the cogged belt 11 in the illustrated example are n=7 of the longitudinal grooves 17 which extend parallel to the longitudinal axis of the cogged belt 11. Correspondingly, n=7 of the electrically conductive elements 15.1 to 15.n are integrated in the cogged belt. The electrically conductive elements 15.1 to 15.n similarly extend parallel to the longitudinal axis of the cogged belt 11 and are accessible from outside via the longitudinal grooves 17. These electrically conductive elements 15.1 to 15.n are flexible and can, depending on the respective design of the belt and the electrically conductive elements, also take over tensile functions additionally to the electrical functions. The cogged belt 11 comes into contact at its rear side 11.2 with contact discs 19.1 to 19.n of the presser roller 16.1. These contact discs 19.1 to 19.n in that case engage in the longitudinal grooves 17 and produce an electrically conductive contact with the electrically conductive elements 15.1 to 15.n.

As schematically indicated in FIG. 1A and in FIG. 1B the presser roller 16.1 is a rotatably mounted roller with an axis 16.2 of rotation. When the drive means 11 moves past the presser roller 16.1 the presser roller 16.1 is set into rotation, wherein the circumferential speed at the outermost circumference of the contact discs 19.1 to 19.n approximately corresponds with the speed of the drive means 11. In that case permanent, non-abrasive connections are present between the contact discs 19.1 to 19.n and the electrically conductive elements 15.1 to 15.n.

One of several possibilities how electrically conductive contacts with the rotating contact discs 19.1 to 19.n can be produced are described in the following. There are numerous other possibilities for that purpose which can also be used in conjunction with the present invention.

In the illustrated example, three wiper rings 8.1 are provided at each of the two end surfaces of the presser roller 16.1. Wiper contacts 8.2 are axially pressed against these wiper rings 8.1 in order to produce contact between the individual contact discs 19.1 to 19.n and a plug connection 9.1. Cables 9.2, for example, can be provided between the wiper contacts 8.2 and the plug connection 9.1. The wiper contacts 8.2 are preferably provided with springs in order to be able to preset a suitable pressing pressure.

The contact with the contact discs 19.1 to 19.n can also be provided at other locations in the region of a first contact means 16, for example by way of wiper bodies which slide on the peripheries of the contact discs 19.1 to 19.n.

The presser roller 16.1 is preferably so arranged and constructed that it exerts a pressure with respect to the drive means 11 and the drive means 11 loops around the presser roller 16.1 or the contact discs 19.1 to 19.n by at least an angle of three degrees.

The first contact means 16 preferably comprises a housing 9 offering protection against unintended contact with voltage-conducting parts and against contamination.

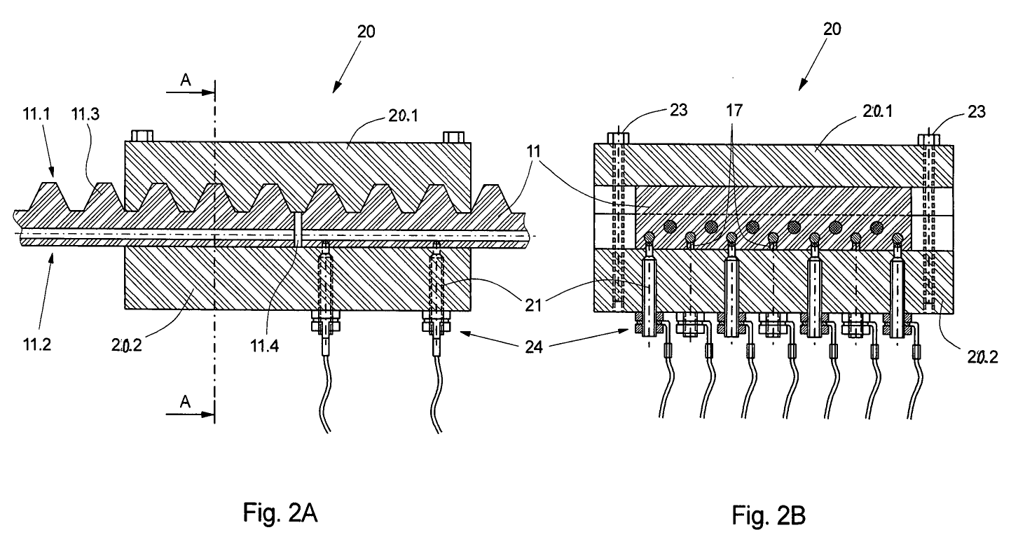

According to the present invention the door drives are typically drives in which the belt-like drive means 11 does not form a closed loop, but has a separating point 11.4 in the region of its coupling to a door leaf (FIG. 2A). In order to be able to produce electrical connections between the conductive elements 15.1 to 15.n, which are embedded in the belt-like drive means 11, and electrical means, which are mounted at a door leaf moved by the drive means, second and, optionally, third contact means 20.1, 20.2 are required as is described in conjunction with FIGS. 2A and 2B. These second and third contact means 20.1, 20.2 advantageously also form a coupling means between the ends, which are present at the separating point 11.4, of the belt-like drive means 11 and also between these drive means and running carriages 14.3, 14.4 carrying the door leaves 14.1, 14.2 (FIG. 3A, 3B).

According to the present invention the second and third contact means, which are denoted in FIG. 2A by 20, comprise at least one contact element 21 which engages in the longitudinal groove 17 of the cogged belt 11 and enables contact with at least one of the electrically conductive elements 15.1 to 15.n. In that case this is preferably a fixed one of the contact element 21 producing a permanent contact with the electrically conductive element, as can be recognized in FIG. 2A and FIG. 2B. The second and third contact means 20 move, in the illustrated example, in fixed relationship with the cogged belt 11 and the door leaf driven by the cogged belt. For this purpose the second contact means 20 can comprise the two elements 20.1 and 20.2 which are so designed that they engage around or clasp the cogged belt 11, wherein they simultaneously couple these at the separating point 11.4 thereof. Screws 23 can be provided in order to fasten the contact means 20 to the cogged belt 11. In the case of the illustrated form of embodiment several of the contact elements 21 are plugged into the element 20.2 and project into the longitudinal grooves 17 of the belt 11. The contact elements 21 can be firmly pressed against the electrically conductive elements 15.1 to 15.n by screws with lock nuts, which are denoted by 24 in FIG. 2A. Cables can, for example, be mounted in the region of the screws with lock nuts 24 in order, for example, to produce a connection with an electrical means 30, 31, 32 at the door leaf 14.1, 14.2 (FIG. 3A).

Such a door drive, as was described and illustrated on the basis of different forms of embodiment, can be used in the most diverse door installations. Some examples are listed in the following without claim to completeness: factory or garage doors, machine doors, lids at vehicles, cupboard doors or other furniture doors, doors or flaps at electrical apparatus, for example at domestic appliances, etc.

FIGS. 3A and 3B show the use of a door drive according to the invention at the elevator car of an elevator installation. In FIG. 3A the door leaves 14.1, 14.2 are illustrated in closed setting and in FIG. 3B in open setting. This is a preferred form of embodiment of the invention.

Only an upper part of the door drive of the elevator car is shown in FIGS. 3A and 3B. The elevator car comprises a car door with the two door leaves 14.1, 14.2 and a door drive 10. The door drive 10 comprises a drive unit 12 and the belt-like drive means 11 for moving the door leaves 14.1, 14.2. In the illustrated example the drive unit 12 comprises a motor 12.1 with a pulley 12.2, a chain or a belt 12.3 and the drive pulley 12.4 for driving the drive means 11. The drive means 11 is, for example, a cogged belt, which comprises several electrically conductive elements for transmission of signals and/or energy, the elements extending in longitudinal direction of the drive means 11.

The drive means 11 can be constructed as shown in FIGS. 1A to 2B. However, other, similarly constructed drive means can also be used. The electrically conductive elements are accessible by way of longitudinal grooves extending parallel to the longitudinal direction of the drive means 11. The first contact means 16 are provided in the region of the drive means 11. In the illustrated form of embodiment these first contact means 16 are seated on a carrier 7 of the door drive 10, to which also guide rails 25 for guidance of the door leaves 14.1, 14.2 are fixed. The drive means 11 moves relative to the first contact means 16, which produce a permanent contact with the electrically conductive elements integrated in the drive means. The first contact means 16 can be arranged in the region of a substantially straight run of the drive means 11 or, like the variant of the contact means 16 shown in dot-dashed lines, in the region of a deflecting pulley 18. Contact means mounted in the region of a deflecting pulley or a drive pulley are always arranged on the side of the drive means remote from the pulley, i.e. the first contact means 16 in this case engage in the region of the rear side of the belt-like drive means 11 on the electrically conductive elements.

The contact means 16 shown in FIGS. 3A and 3B can, for example, be constructed analogously to the contact means shown in FIGS. 1A and 1B.

As illustrated in FIGS. 3A and 3B, the door leaf 14.1 is mechanically coupled with the drive means by way of the second contact means 20.1 and the door leaf 14.2 is mechanically coupled with the drive means 11 by way of the third contact means 20.2. The third contact means 20.2 are identical with the second contact means 20.1, which were described in the foregoing in conjunction with FIGS. 2A and 2B. The door leaves 14.1 and 14.2 move apart from one another or towards one another when the drive means 11 is set in motion by the drive unit 12. The electrical means 30, 31, 32 which move in fixed relationship with the corresponding door leaves 14.1, 14.2 are disposed at one or both of the door leaves 14.1, 14.2 or in the region of the door leaves 14.1, 14.2. The electrical means 30 can be an indicator panel, for example, provided in the door leaf 14.1, and/or the door leaves can have light curtain strips as the electrical means 31 at the door leaf edges, and/or electrical actuators as the electrical means 32 for actuation of a car door/shaft door coupling can be mounted at running carriages 14.3, 14.4 of the door leaves. These electrical means 30, 31, 32 have to be supplied with electrical power or have to be in a position of receiving or delivering electrical signals.

According to the present invention the electrical means 30, 31, 32 are for this purpose conductively connected (for example, by cables) with the fixed contact elements 21 of the second and third contact means 20.1, 20.2. The left-hand leaf door 14.1 is connected with the second contact means 20.1 and the right-hand leaf door 14.2 is connected with the third contact means 20.2.

By means of the described invention a power supply and/or signal transmission, for example, from a control 6 can take place by way of a cable loom 5, the first contact means 16, the drive means 11 with the electrically conductive elements integrated therein and the second contact means 20.1 to the electrical means 30, 31, 32 at the first door leaf 14.1. In analogous manner electrical connections can also be established to the second door leaf 14.2, in this case by way of the third contact means 20.2.

A form of embodiment is particularly preferred in which the first contact means 16 together with its presser roller 16.1 is not a belt-guiding component of the door drive of the car doors and thus can be positioned at many various locations in the region of the drive means 11.

As belt-like drive means there is denoted, in the present connection, a drive means having a longitudinal extent and a substantially rectangular cross-section and flexible in itself. As typical examples mention may be made of flat belts, cogged belts and wedge-ribbed belts, wherein this list is not to be understood as restrictive.

The electrically conductive elements in the drive means can have any cross-sectional shapes, wherein round or oval cross-sections are preferred. Preferably, use is made of electrical conductors which form wire cables produced from fine wires and have several strands. Copper alloys, with strength characteristics optimized for this application, are particularly suitable as wire material.

Metal tapes, which, for example, consist of spring bronze, can also be used as electrically conductive elements.

Advantageously, the electrically conductive elements are integrated in the belt-like drive means during manufacture thereof. In the case of a preferred method of manufacture the electrically conductive elements enter the drive means in that they—together with tensile carriers—are embedded in the belt casing during manufacture thereof by means of extrusion. The requisite longitudinal grooves are in that case produced in the same extrusion process.

The electrically conductive elements in the drive means can also be realized by plating flexible foils of copper alloys, wherein the foils are fixed by, for example, gluing to the base of longitudinal grooves or simply to the surface of the belt-like drive means. The foils are in that case advantageously arranged in the region of the zone, which is neutral with respect to bending, of the flexible drive means.

It is regarded as a significant advantage of the present invention that the first contact means can be positioned at many different locations of the door drive. The location of the contact means can thus be selected so that it is as favorable as possible for the feed and/or derivation of signals and/or energy. Thus, the contact means can, for example, be arranged in the immediate vicinity of a control. Moreover, for example, the contact means can be arranged at locations where unusable space is present or where they are protected against contamination.

A particular advantage of the equipment according to the present invention consists in that existing door drives can be subsequently equipped with this equipment in that a conventional belt-like drive means is replaced by a drive means according to the invention, wherein at least one first contact means is arranged in a region, which is readily accessible, of the drive means. The present invention can be offered as a retrofit set, mounting of which is simple.

Investigations have shown that a contact region of sufficient length should be ensured between the first contact means and the electrically conductive element. Advantageously this is achieved in that the first contact means so co-operates with the drive means that the electrically conductive elements loop around the disc-shaped contact elements by an angle of at least 3°. A permanent, reliable and disturbance-free contact can thereby be guaranteed even in extreme situations. Moreover, contaminations of a subordinate roller then do not play any part.

The contact discs 19.1 to 19.n rolling along the electrically conductive elements can be replaced by wiper contacts sliding on the conductive elements. Such a solution is indeed more economic, but has the disadvantage that it produces wiping noises and, in the case of transmission of electronic signals, can cause disturbances.

The invention can advantageously also be supplemented or expanded by communications means operating in cable-free manner in that these communications means transmit low-power signals and the equipment according to the present invention transmits electrical currents of higher power.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A door drive with a drive unit and a belt-like drive means for moving at least one door leaf of a sliding door comprising: the drive means including at least one electrically conductive element extending in a longitudinal direction of the drive means for transmission of at least one of electrical signals and electrical energy to electrical means at the at least one door leaf.

2. The door drive according to claim 1 including a first contact means fixed relative to movement of the drive means and arranged in a region of one of a substantially straight run of the drive means, a drive pulley engaging the drive means and a deflecting pulley engaging the drive means, said first contact means being on a side of the drive means remote from the drive pulley or the deflecting pulley, wherein said first contact means produces a permanent contact with said at least one electrically conductive element.

3. The door drive according to claim 1 wherein said at least one electrically conductive element is embedded in the drive means and the drive means has at least one longitudinal groove formed therein enabling access by a first contact means to said at least one electrically conductive element.

4. The door drive according to claim 3 wherein the drive means has a front side and a rear side and said at least one longitudinal groove is disposed on the rear side of the drive means, whereby when the door leaf is moving the rear side of the drive means runs past said first contact means and said first contact means produces a permanent contact with said at least one electrically conductive element from the rear side of the drive means.

5. The door drive according to claim 1 wherein the door drive is part of an elevator installation and the door leaf is an elevator car door leaf or an elevator shaft door leaf.

6. The door drive according to claim 1 wherein the drive means is a cogged belt having a front side with teeth, and the drive means runs around a drive pulley included in the drive unit in mechanically positive connection with said drive pulley.

7. The door drive according to claim 1 wherein said at least one electrically conductive element is embedded in the drive means and the drive means has at least one longitudinal groove formed therein enabling access by a first contact means to said at least one electrically conductive element, said first contact means having at least one rotatably mounted contact element which engages at least partly in the longitudinal groove and contacts said at least one electrically conductive element.

8. The door drive according to claim 7 wherein said at least one rotatably mounted contact element is attached to a presser roller, said presser roller not being a driving roller or a deflecting roller for the drive means.

9. The door drive according to claim 8 wherein said presser roller is positioned in a region of a substantially straight run of the drive means, said presser roller exerting a pressure on the drive means and the drive means looping around said presser roller at least by an angle of three degrees.

10. The door drive according to claim 1 including a first contact means fixed relative to movement of the drive means and producing a permanent contact with said at least one electrically conductive element, a second contact means connected with the drive means and the door leaf and having at least one contact element enabling permanent contact with said at least one electrically conductive element wherein said at least one contact element moves in a fixed relationship to the door leaf.

11. An elevator installation with an elevator car having a car sliding door with at least one door leaf and a door drive, the door drive including a drive unit and a belt-like drive means for moving the at least one door leaf, comprising: the drive means including at least one electrically conductive element extending in a longitudinal direction of the drive means for transmission of at least one of electrical signals and electrical energy to electrical means at the at least one door leaf.

12. The elevator installation according to claim 11 including:
a first contact means, relative to which the drive means moves, arranged in a region of one of a substantially straight run of the drive means, a drive pulley engaging the drive means and a deflecting pulley engaging the drive means, said first contact means being on a side of the drive means remote from the drive pulley or the deflecting pulley, wherein said first contact means produces a permanent contact with said at least one electrically conductive element; and
the at least one door leaf is coupled with the drive means and moves when the drive means moves.

13. The elevator installation according to claim 12 including:
said first contact means being connected with the elevator car to be stationary relative thereto; and
electrical means which move in fixed relationship to the at least one door leaf are positioned at the at least one door leaf or in a region of the at least one door leaf, wherein said electrical means are electrically connected by said at least one electrically conductive element with said first contact means.

14. The elevator installation according to claim 11 including a second contact means connected with the drive means and the at least one door leaf and having at least one contact element enabling permanent contact with said at least one electrically conductive element wherein said at least one contact element moves in a fixed relationship to the door leaf.
